(19) United States
(12) Patent Application Publication
(10) Pub. No.: US 2025/0159770 A1
(43) Pub. Date: May 15, 2025

(54) AIR FRESHENER ASSEMBLY FOR A MICROWAVE OVEN APPLIANCE

(71) Applicant: Haier US Appliance Solutions, Inc., Wilmington, DE (US)

(72) Inventor: Bagawathkumar Chellappan, Prospect, KY (US)

(21) Appl. No.: 18/505,502

(22) Filed: Nov. 9, 2023

(51) Int. Cl. H05B 6/80

(52) U.S. Cl. CPC H05B 6/80

(57) ABSTRACT

A microwave oven appliance includes a cabinet, the cabinet forming a cooking cavity; a door rotatably coupled to the cabinet to provide selective access to the cooking cavity; a ventilation system provided within the cabinet and configured to circulate air, the ventilation system including an exhaust vent; and a freshener assembly attached to the microwave oven appliance at the exhaust vent, the freshener assembly being configured to receive a replaceable scent cartridge. The freshener assembly includes a casing bottom, the casing bottom including a plurality of bottom apertures; a casing top, the casing top including a plurality of top apertures, wherein the casing top is rotatably connected to the casing bottom; and a connector hook configured to selectively connect the freshener assembly to the exhaust vent.

### FIELD OF THE INVENTION

The present subject matter relates generally to kitchen appliances, and more particularly to attachable air fresheners for microwave oven appliances.

### BACKGROUND OF THE INVENTION

Microwave oven appliances generally include a cabinet that defines a cooking chamber for receipt of food items for cooking. These appliances typically include one or more heating elements for generating energy to heat the food items during a cooking process. For example, microwave ovens typically include at least one source of electromagnetic radiation in the microwave frequency range, such as a cavity magnetron. Generally, microwave oven appliances include an air handler or fan to circulate air either through the appliance or through an ambient atmosphere around the appliance (e.g., throughout the kitchen). These fans can blow air out from the appliance via an exhaust vent.

Food and other items heated or cooked within the kitchen (e.g., within the cooking chamber or cavity or within an oven) can produce strong odors. These odors may emanate from the appliance and linger in and around the room in which the microwave is situated (such as a kitchen or kitchenette). Users of the appliance and any patrons within the room or space may find the odors to be unpleasant. However, current methods for reducing kitchen odors have several drawbacks. For instance, separate scent releasers plugged into different outlets may reduce odors in places away from the source of the odor, resulting in less than desirable effects.

Accordingly, a microwave oven appliance that obviates one or more of the above-mentioned drawbacks would be beneficial. In particular, a microwave oven appliance including an attached and replaceable air freshener assembly would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a microwave oven appliance is provided. The microwave oven appliance may include a cabinet, the cabinet forming a cooking cavity; a door rotatably coupled to the cabinet to provide selective access to the cooking cavity; a ventilation system provided within the cabinet and configured to circulate air, the ventilation system including an exhaust vent; and a freshener assembly attached to the microwave oven appliance at the exhaust vent, the freshener assembly being configured to receive a replaceable scent cartridge. The freshener assembly may include a casing bottom, the casing bottom including a plurality of bottom apertures; a casing top, the casing top including a plurality of top apertures, wherein the casing top is selectively connected to the casing bottom; and a connector hook configured to selectively connect the freshener assembly to the exhaust vent.

In another exemplary aspect of the present disclosure, a microwave oven appliance is provided. The microwave oven appliance may include a cabinet, the cabinet forming a cooking cavity; a door rotatably coupled to the cabinet to provide selective access to the cooking cavity; a ventilation system provided within the cabinet and configured to circulate air, the ventilation system including an exhaust vent; and a freshener assembly attached to the microwave oven appliance at the exhaust vent, the freshener assembly being configured to receive a replaceable scent cartridge. The freshener assembly may include a casing bottom, the casing bottom including a plurality of bottom apertures; a casing top, the casing top including a plurality of top apertures, wherein the casing top is selectively connected to the casing bottom; a latch receptacle protruding from the casing bottom along the lateral direction; a latch hook protruding from the casing top along the lateral direction, the latch hook being aligned within the latch receptacle to be selectively received therein; and a connector hook configured to selectively connect the freshener assembly to the exhaust vent.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a microwave oven appliance according to exemplary embodiments of the present disclosure.

FIG. 2 provides a perspective view of the exemplary microwave oven appliance of FIG. 1.

FIG. 3 provides a top view of a freshener assembly according to exemplary embodiments of the present disclosure.

FIG. 4 provides a top perspective view of the exemplary freshener assembly of FIG. 3 in an open position.

FIG. 5 provides a cross-section view of the exemplary fastener assembly of FIG. 3 taken along line A-A.

FIG. 6 provides a perspective view of a freshener assembly according to exemplary embodiments of the present disclosure.

FIG. 7 provides a perspective view of the exemplary freshener assembly of FIG. 6 in a withdrawn position.

FIG. 8 provides a perspective view of the exemplary freshener assembly of FIG. 6 in an open position.

FIG. 9 provides a perspective view of a holster of the exemplary freshener assembly of FIG. 6.

FIG. 10 provides a bottom perspective view of the exemplary freshener assembly of FIG. 6.

FIG. 11 provides a perspective view of a freshener assembly according to exemplary embodiments of the present disclosure.

FIG. 12 provides a perspective view of the exemplary freshener assembly of FIG. 11 in a rotated position.

FIG. 13 provides a cross-section view of the exemplary freshener assembly of FIG. 11 taken along line B-B.

FIG. 14 provides a front perspective view of a top of the exemplary microwave oven appliance of FIG. 1.

FIG. 15 provides a front perspective view of the exemplary microwave oven appliance of FIG. 14.

FIG. 16 provides a cross-section view of the exemplary microwave oven appliance of FIG. 14 taken along line C-C.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

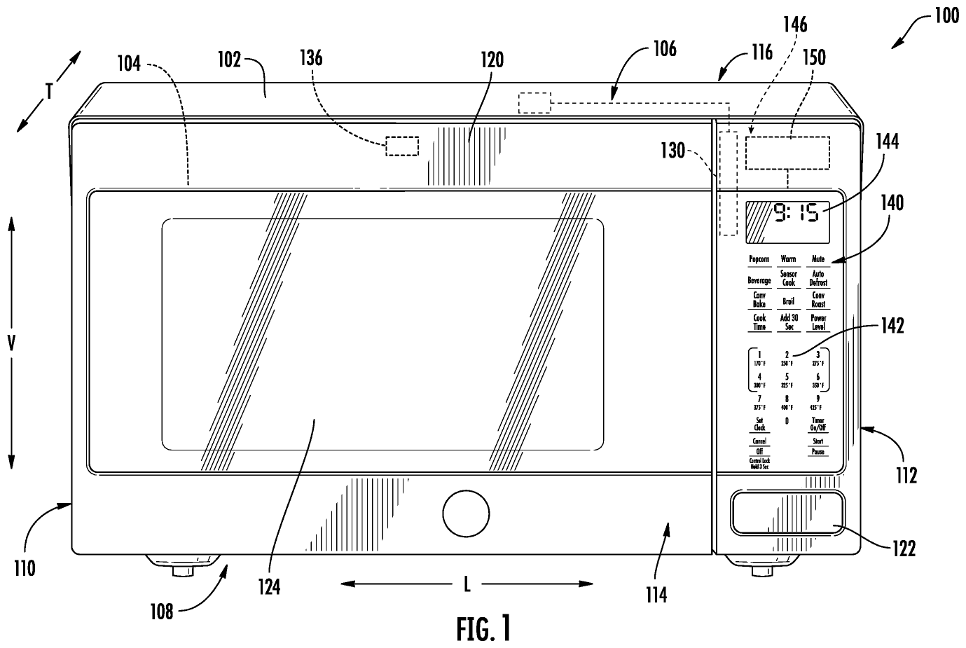

Referring now to the figures, FIG. 1 provides a front view of a microwave oven 100 as may be employed with the present subject matter. Microwave oven 100 includes an insulated cabinet 102 that defines a cooking chamber 104 for receipt of food items for cooking. As will be understood by those skilled in the art, microwave oven 100 is provided by way of example only, and the present subject matter may be used in any suitable microwave oven, such as a countertop microwave oven, an over-the-range microwave oven, etc. Thus, the example embodiment shown in the figures is not intended to limit the present subject matter to any particular cooking chamber configuration or arrangement.

As illustrated, microwave oven 100 generally defines a vertical direction V, a lateral direction L, and a transverse direction T, each of which is mutually perpendicular, such that an orthogonal coordinate system is generally defined. Cabinet 102 of microwave oven 100 extends between a top 106 and a bottom 108 along the vertical direction V, between a first side 110 (left side when viewed from front) and a second side 112 (right side when viewed from front) along the lateral direction L, and between a front 114 and a rear 116 along the transverse direction T.

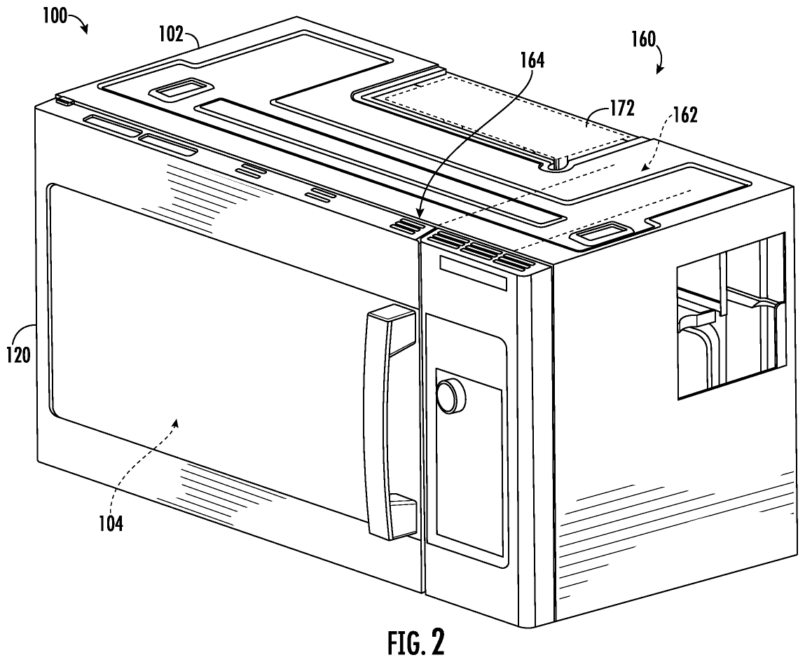

Microwave oven 100 includes a door 120 that is rotatably attached to cabinet 102 in order to permit selective access to cooking chamber 104. A handle (FIG. 2) may be mounted to door 120 to assist a user with opening and closing door 120 in order to access cooking chamber 104. As an example, a user can pull on the handle mounted to door 120 to open or close door 120 and access cooking chamber 104. Alternatively, microwave oven 100 may include a door release button 122 that disengages or otherwise pushes open door 120 when depressed. Glass windowpanes 124 provide for viewing the contents of cooking chamber 104 when door 120 is closed and also assist with insulating cooking chamber 104.

Microwave oven 100 is generally configured to heat articles, e.g., food or beverages, within cooking chamber 104 using electromagnetic radiation. Microwave appliance 100 may include various components which operate to produce the electromagnetic radiation, as is generally understood. For example, microwave appliance 100 may include a microwave heating assembly 130 which may include a magnetron (such as, for example, a cavity magnetron), a high voltage transformer, a high voltage capacitor and a high voltage diode.

According to exemplary embodiments, microwave oven 100 may further include an inverter power supply that is operably coupled to microwave heating assembly 130 to provide energy from a suitable energy source (such as an electrical outlet) to microwave heating assembly 130, e.g., the magnetron. The magnetron may convert the energy to electromagnetic radiation, specifically microwave radiation. Microwave heating assembly 130 and/or the inverter power supply may include other suitable components, such as a capacitor that generally connects the magnetron and power supply, such as via high voltage diode, to a chassis. Microwave radiation produced by the magnetron may also be transmitted through a waveguide to cooking chamber 104.

The structure and intended function of microwave ovens are generally understood by those of ordinary skill in the art and are not described in further detail herein. According to alternative embodiments, microwave oven may include one or more heating elements, such as electric resistance heating elements, gas burners, other microwave heating elements, halogen heating elements, or suitable combinations thereof, are positioned within cooking chamber 104 for heating cooking chamber 104 and food items positioned therein.

Microwave oven 100 may include additional features to improve heating uniformity and precision. For example, according to an exemplary embodiment, microwave oven 100 may include a turntable rotatably mounted within cooking chamber 104. The turntable may be selectively rotated during a cooking process to ensure improved temperature uniformity for the object being heated. In addition, microwave oven 100 may include an infrared temperature sensing array 136 that can measure temperatures across the entire bottom of the cooking chamber 104. Temperature sensing array 136 may detect temperatures at various distinct temperature locations, may associate certain locations with the food items being cooked, and may use a subset of the temperature data as feedback for regulating the inverter power supply and microwave heating assembly 130 for improved precision. For example, temperature sensing array 136 may include one or more infrared sensors mounted to a top of cooking chamber 104 for periodically or continuously monitoring a surface temperature of the item being heated.

A user interface panel 140 and a user input device 142 may be positioned on an exterior of the cabinet 102. The user interface panel 140 may represent a general purpose Input/Output (“GPIO”) device or functional block. In some embodiments, the user interface panel 140 may include or be in operative communication with user input device 142, such as one or more of a variety of digital, analog, electrical, mechanical or electro-mechanical input devices including rotary dials, control knobs, push buttons, and touch pads. The user input device 142 is generally positioned proximate to the user interface panel 140, and in some embodiments, the user input device 142 may be positioned on the user interface panel 140. The user interface panel 140 may include a display component 144, such as a digital or analog display device designed to provide operational feedback to a user.

Generally, microwave oven 100 may include a controller 150 in operative communication with the user input device 142. The user interface panel 140 of the microwave oven 100 may be in communication with the controller 150 via, for example, one or more signal lines or shared communication busses, and signals generated in controller 150 operate microwave oven 100 in response to user input via the user input devices 142. Input/Output (“I/O”) signals may be routed between controller 150 and various operational components of microwave oven 100. Operation of microwave oven 100 can be regulated by the controller 150 that is operatively coupled to the user interface panel 140.

Controller 150 is a “processing device” or “controller” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of microwave oven 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, a controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Referring now to FIG. 2, another embodiment of microwave oven 100 will be described. In this embodiment, like reference numerals will be used to refer to like features. As shown, microwave oven 100 may include a ventilation system 160. For instance, one or more ducts 162 maybe formed within microwave oven 100 (e.g., within cabinet 102) separate from cooking chamber 104. Ducts 162 may facilitate air movement therethrough. For instance, ducts 162 may be in fluid contact with an ambient atmosphere (e.g., within the room in which microwave oven 100 is located). Thus, ventilation system 160 may include an exhaust vent 164. Exhaust vent 164 may define an outlet of ducts 162 (e.g., through which air is exhausted to the ambient atmosphere of the room). For example, a user may select a recirculation ventilation operation to circulate air through the room (e.g., kitchen). The air may thus be released into the room via exhaust vent 164.

Exhaust vent 164 may formed in cabinet 102. For instance, exhaust vent 164 may be defined at a top (along the vertical direction V) and front (along the transverse direction T) of cabinet 102. According to some embodiments (e.g., as shown in FIG. 2), exhaust vent is formed in a top panel of cabinet 102. Additionally or alternatively, exhaust vent 164 may be formed in a front panel of cabinet 102. Further still, exhaust vent 164 may be formed in door 120. For instance, exhaust vent 164 may be formed in a top of door 120 (e.g., downward along the vertical direction V).

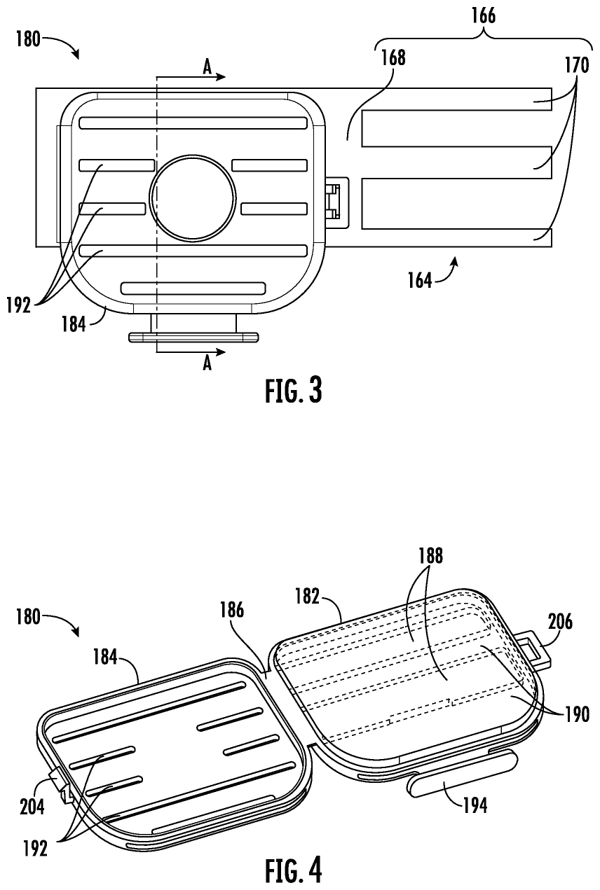

Exhaust vent 164 may include a grate, for example. As shown most clearly in FIGS. 3, 6, 7, 10, 12, and 14, exhaust vent 164 may define a plurality of apertures formed by a plurality of prongs 166. In detail, the plurality of prongs 166 may include a plurality of transverse prongs 168 (e.g., extending along the transverse direction T) and a plurality of lateral prongs 170 (e.g., extending along the lateral direction L). Transverse prongs 168 may intersect with lateral prongs 170 at junction points to define the plurality of apertures. Each of the plurality of apertures may have any suitable size. For example, each aperture may be elongated along the lateral direction L. However, additional or alternative sizes or shapes of apertures may be incorporated and the disclosure is not limited to the examples provided herein.

Ventilation system 160 may include a fan (or air handler) 172. Fan 172 may be positioned within microwave oven 100 (e.g., within cabinet 102). For instance, fan 172 may be positioned within ducts 162. Accordingly, fan 172 may selectively urge a flow of air through ducts 162 to be exhausted out of exhaust vent 164. Fan 172 may be an axial fan positioned within cabinet 102. However, it should be appreciated that according to alternative embodiments, fan 172 may be positioned at any other suitable location and may be any other suitable fan type, such as a tangential fan, a centrifugal fan, etc.

In addition, according to an exemplary embodiment, fan 172 is a variable speed fan such that it may rotate at different rotational speeds, thereby generating different air flow rates. In this manner, the amount of air circulated through ducts 162 may be continuously and precisely regulated. Moreover, by pulsing the operation of fan 172 or throttling fan 172 between different rotational speeds, the flow of air through ducts 162 may have a different flow velocity or may generate a different flow pattern. Thus, the air may be forced out of exhaust vent 164 via fan 172.

Referring now to FIGS. 3 through 5, an embodiment of a freshener assembly 180 will be described in detail. Freshener assembly 180 may be selectively attached to microwave oven 100. For instance, freshener assembly 180 may be selectively attached to exhaust vent 164. As mentioned above, the plurality of prongs 166 may define apertures in exhaust vent 164, to which freshener assembly 180 may be attached. Freshener assembly 180 may be configured to receive a replaceable scent cartridge. For instance, freshener assembly 180 may provide a space into which a cartridge or piece having scent-releasing capabilities may be accommodated. Additionally or alternatively, freshener assembly 180 may selectively receive an odor absorber. For instance, a packet or cartridge containing an odor absorber (e.g., baking soda, activated charcoal, hydrogen peroxide, etc.) may be positioned within freshener assembly 180 to absorb odors produced during heating processes within microwave oven 100.

Freshener assembly 180 may be openable to provide access to the receiving space. For instance, freshener assembly 180 may include a casing bottom 182 and a casing top 184. Casing top 184 may be rotatably coupled to casing bottom 182 (e.g., as shown in FIG. 4). Thus, freshener assembly 180 may include a hinge 186. Hinge 186 may allow casing top 184 to rotate with respect to casing bottom 182. In some instances, hinge 186 is a resilient member (e.g., a spring) connected to each of casing bottom 182 and casing top 184. Further still, hinge 186 may be integrally formed with casing bottom 182 and casing top 184 as a single piece. Thus, hinge 186 may be a relatively thin plastic member with a high elasticity (e.g., able to flex). Hinge 186 may be positioned at any suitable edge of freshener assembly 180. For instance, as shown in FIG. 4, hinge 186 may be positioned at a first lateral edge of freshener assembly 180. However, it should be understood that hinge 186 may be positioned in additional or alternative locations to allow casing top 184 to rotate with respect to casing bottom 182.

Casing bottom 182 may include a plurality of apertures (e.g., bottom apertures) 188. For instance, one or more cross-braces 190 may extend a width (e.g., along the lateral direction L) of casing bottom 182 from a first side to a second side. Apertures 188 may be formed adjacent to cross-brace 190. For instance, a first aperture 188 may be formed in front of cross-brace 190 while a second aperture 188 may be formed behind cross-brace 190 (e.g., along the transverse direction T). It should be understood that the number and positions of apertures 188 and cross-braces 190 are provided by way of example, and any suitable number and formation of apertures 188 and cross-braces 190 may be incorporated in specific embodiments, such as two or more cross-braces extending along the transverse direction T, each of the lateral direction L and the transverse direction T, or at an angle between the lateral direction L and the transverse direction T. For instance, apertures 188 may be matched with the apertures in exhaust vent 164. For one example, apertures 188 are aligned along the vertical direction V with the apertures of exhaust vent 164 such that air flowing from exhaust vent 164 flows unimpeded into and through casing bottom 182.

Casing top 184 may include a plurality of apertures (e.g., top apertures) 192. The plurality of top apertures 192 may be formed through casing top 184 along the vertical direction V. Thus, the plurality of apertures 192 may allow fluid communication between the receiving space (e.g., between casing bottom 182 and casing top 184) and the ambient atmosphere (e.g., within the room). Any suitable number of apertures 192 may be included, and the disclosure is not limited to the examples provided herein. One or more of apertures 192 may extend along the lateral direction L from a first end to a second end of casing top 184. Additionally or alternatively, the plurality of apertures 192 may be spaced apart from each other along the transverse direction T. Together with the plurality of bottom apertures 188, the plurality of top apertures 192 may allow a flow of air from exhaust vent 164 to pass through freshener assembly 180. Accordingly, when a scent cartridge is positioned within the receiving space, a freshening effect may be realized during an operation of fan 172.

Freshener assembly 180 may include a slider tab 194. Slider tab 194 may extend or protrude from casing bottom 182. For instance, slider tab 194 may protrude forward (e.g., along the transverse direction T) from a front face of casing bottom 182. Slider tab 194 may extend predominantly along the lateral direction L. For example, slider tab 194 is elongated in the lateral direction L. Accordingly, a user may easily move or shift freshener assembly 180 along the lateral direction L or pressing or pushing slider tab 194 along the lateral direction L.

Freshener assembly 180 may include a connector hook 196. Connector hook 196 may selectively connect freshener assembly 180 to cabinet 102. For instance, connector hook 196 may connect freshener assembly 180 to exhaust vent 164. Connector hook 196 may interact with the plurality of prongs 166. In some embodiments, connector hook 196 hooks onto (e.g., at least partially around) a lateral prong 170.

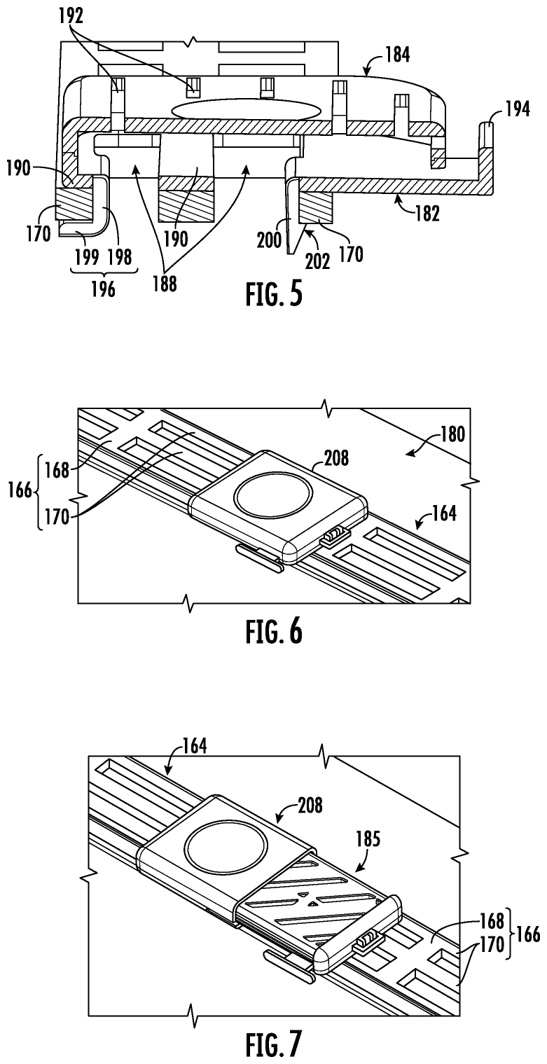

Connector hook 196 may include a vertical tab 198 and a horizontal tab 199. Vertical tab 198 may extend from a bottom face of casing bottom 182 (e.g., along the vertical direction V). As shown most clearly in FIG. 5, vertical tab 198 extends downward from an edge of a cross-brace 190 (e.g., a rearmost cross-brace). In at least some instances, vertical tab 198 is offset forward from a rear edge of casing bottom 182 (e.g., forward along the transverse direction T). Thus, at least a portion of casing bottom 182 (e.g., cross-brace 190) may rest on a top of exhaust vent 164. Vertical tab 198 may extend through exhaust vent 164 along the vertical direction V (e.g., when freshener assembly 180 is in an installed position). For instance, a distal end of vertical tab 198 may be positioned below a bottom face of exhaust vent 164.

Horizontal tab 199 may extend from the distal end of vertical tab 198. For instance, horizontal tab 199 may extend rearward (e.g., along the transverse direction T) from the distal end of vertical tab 198. Horizontal tab 199 may be positioned below exhaust vent 164 (e.g., below lateral prong 170) along the vertical direction V (e.g., when freshener assembly 180 is in the installed position). As would be expected, a portion of exhaust vent 164 (e.g., lateral prong 170) may be positioned between horizontal tab 199 and casing bottom 182 along the vertical direction V. Freshener assembly 180 may thus be held in place with respect to exhaust vent 164.

Freshener assembly 180 may include a casing snap hook 200. Casing snap hook 200 may be spaced apart from connector hook 196 (e.g., along the transverse direction T). For instance, casing snap hook 200 may be positioned in front of connector hook 196 along the transverse direction T. Casing snap hook 200 may protrude or extend along the vertical direction V. According to some embodiments, casing snap hook 200 protrudes from casing bottom 182 downward along the vertical direction V.

Casing snap hook 200 may interact with exhaust vent 164. For instance, casing snap hook 200 may selectively engage a lateral prong 170 (e.g., a different lateral prong 170 from connector hook 196). For instance, when connector hook 196 is inserted into exhaust vent 164 and engaged with the first lateral prong 170, freshener assembly 180 may then be rotated downward such that casing snap hook 200 passes by the second lateral prong 170. Accordingly, casing snap hook 200 may protrude through exhaust vent 164 (e.g., similar to connector hook 196). According to at least some embodiments, casing snap hook 200 is positioned inward with respect to the second lateral prong 170 (e.g., along the transverse direction T).

Casing snap hook 200 may include a hook latch 202. Hook latch 202 may contact an underside of the second lateral prong 170 to restrict an upward movement or shifting of freshener assembly 180. Thus, when casing snap hook 200 is moved into the installed position, freshener assembly 180 may be snapped into place with respect to cabinet 102 (e.g., exhaust vent 164). It should be understood that additional or alternative connection means may be incorporated into freshener assembly 180 and/or exhaust vent 164. For instance, one or more of an adhesive, a magnet, a fastener, a clip, or the like may be included.

Freshener assembly 180 may include a latch hook 204 and a latch receptable 206. In detail, latch hook 204 may protrude or extend from casing top 184 while latch receptacle 206 may protrude or extend from casing bottom 182. Latch hook 204 may be selectively received within latch receptacle 206 to couple casing bottom 182 to casing top 184 (e.g., in a closed position). For instance, when casing top 184 is rotated (e.g., about hinge 186), latch hook 204 is inserted into latch receptacle 206 to enclose the receiving space between casing bottom 182 and casing top 1184.

Latch hook 204 may extend from a lateral edge of casing top 184. For instance, latch hook may extend along the vertical direction V (e.g., perpendicular to a top face of casing top 184). Latch hook 204 may include a catch face 205. Catch face 205 may protrude through latch receptacle 206 (e.g., in the closed position) and contact an underside of latch receptacle 206. Latch receptacle 206 may extend from a lateral edge of casing bottom 182 (e.g., corresponding to latch hook 204 in the closed position). Latch receptacle 206 may define a receiving aperture into which latch hook 204 may be received. Additional or alternative connecting means may be incorporated. For example, one or more of an adhesive, a magnet, a clip, a fastener, or the like may be used in addition to or in place of latch hook 204 and latch receptacle 206.

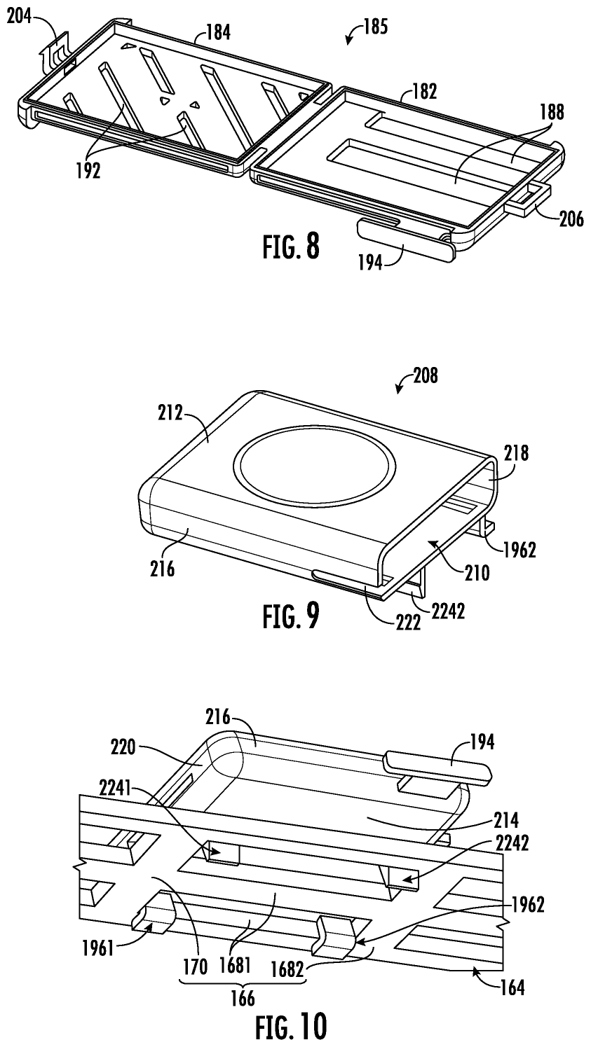

Referring now to FIGS. 6 through 10, a freshener assembly 180 according to another embodiment will be described in detail. Due to the similarities between embodiments described herein, like reference numerals may be used to refer to the same or similar features. In particular, with reference to FIG. 8, freshener assembly 180 may include casing bottom 182 and casing top 184, connected to each other via hinge 186. Casing bottom 182 may include the plurality of bottom apertures 188 while casing top 184 may include the plurality of top apertures 192. The plurality of top apertures 192 may be oriented on an angle (e.g., with respect to the lateral direction L and the transverse direction T). However, it should be understood that the orientation of the plurality of top apertures 192 (and the plurality of bottom apertures 188) may vary according to specific embodiments. Freshener assembly 180 may further include slider tab 194. According to this embodiment, slider tab 194 may be offset (e.g., along the lateral direction L). Freshener assembly 180 may further include latch hook 204 and latch receptacle 206, as described above.

According to this embodiment, freshener assembly 180 may include a holster 208. With reference to FIGS. 6, 7, 9, and 10, holster 208 may selectively receive casing bottom 182 and casing top 184 (collectively referred to herein as a casing 185) therein. For instance, holster 208 may define a receiving cavity 210. Receiving cavity 210 may be shaped similar to casing 185 (e.g., such that casing 185 may slide into and out of holster 208). For instance, casing 185 may slide between an inserted position (FIG. 6) and a withdrawn position (FIG. 7) with respect to receiving cavity 210. Holster 208 may define a top panel 212, a bottom panel 214, a front panel 216, a rear panel 218, and a lateral panel 220. Together, the top, bottom, front, rear, and lateral panels 212, 214, 216, 218, 220 may define receiving cavity 210. Each of the top, bottom, front, rear, and lateral panels 212, 214, 216, 218, 220 may be solid. For instance, no apertures or through holes may be defined therethrough. Advantageously, when casing 185 is inserted into receiving cavity 210, air may be restricted from flowing therethrough, thus preventing any scent release via exhaust vent 164.

Front panel 216 may include a slit 222. Slit 222 may extend along the lateral direction L. Slit 222 may receive slider tab 194 therein (e.g., when casing 185 is inserted into receiving cavity 210). Accordingly, slit 222 may be positioned at a lateral edge of front panel 216 (e.g., opposite lateral panel 220). For instance, an opening to receiving cavity 210 may be formed opposite lateral panel 220 (e.g., along the lateral direction L). Slit 222 may initiate at the opening and extend a predetermined distance into front panel 216 along the lateral direction L. Thus, when casing 185 is inserted into receiving cavity 210, slider tab 194 is accommodated within slit 222.

Referring now specifically to FIG. 10, connector hook 196 may protrude from a bottom face of bottom panel 214 of holster 208 (e.g., downward along the vertical direction V). Additionally or alternatively, a pair of connector hooks 196 may extend from bottom panel 214. The pair of connector hooks 196 may be spaced apart from each other along the lateral direction L. Notably, the pair of connector hooks 196 may be spaced apart by a predetermined distance. The predetermined distance may be based upon a spacing of transverse prongs 168.

A first connector hook 1961 may be located at or near a first lateral edge of holster 208 (e.g., bottom panel 214). A second connector hook 1962 may thus be located at or near a second lateral edge of holster 208 opposite first connector hook 1961. First connector hook 1961 may contact a first transverse prong 1681 while second connector hook 1962 contacts a second transverse prong 1682. Additionally or alternatively, first connector hook 1961 may be positioned on a first lateral side of first transverse prong 1681 while second connector hook 1962 is positioned on a second lateral side of second transverse prong 1682 (e.g., opposite the first lateral side). Advantageously, holster 208 may be restricted from lateral movement by the location of each of first connector hook 1961 and second connector hook 1962.

Holster 208 may include a holster snap hook 2241. Holster snap hook 2241 may be a first holster snap hook 2241. First holster snap hook 2241 may protrude from a bottom face of bottom panel 214 of holster 208 (e.g., downward along the vertical direction V). Additionally or alternatively, a second holster snap hook 2242 may extend from bottom panel 214. First and second holster snap hooks 2241, 2242 may be spaced apart from each other along the lateral direction L. Notably, first and second holster snap hooks 2241, 2242 may be spaced apart by a predetermined distance. The predetermined distance may be based upon a spacing of transverse prongs 168 (e.g., similar to the pair of connector hooks 196). Additionally or alternatively, first and second holster snap hooks 2241, 2242 may be spaced apart from the pair of connector hooks 196 along the transverse direction T (e.g., forward).

First holster snap hook 2241 may be located at or near the first lateral edge of holster 208 (e.g., bottom panel 214). Second holster snap hook 2242 may thus be located at or near the second lateral edge of holster 208 opposite first holster snap hook 2241. First holster snap hook 2241 may contact first transverse prong 1681 while second holster snap hook 2242 contacts second transverse prong 1682. Additionally or alternatively, first holster snap hook 2241 may be positioned on the first lateral side of first transverse prong 1681 while second holster snap hook 2242 is positioned on the second lateral side of second transverse prong 1682 (e.g., opposite the first lateral side). Advantageously, holster 208 may be restricted from lateral movement by the location of each of first holster snap hook 2241 and second holster snap hook 2242. Casing 185 may thus be easily slid out from holster 208 (e.g., along the lateral direction L) to allow air to flow therethrough, thus producing a scent release.

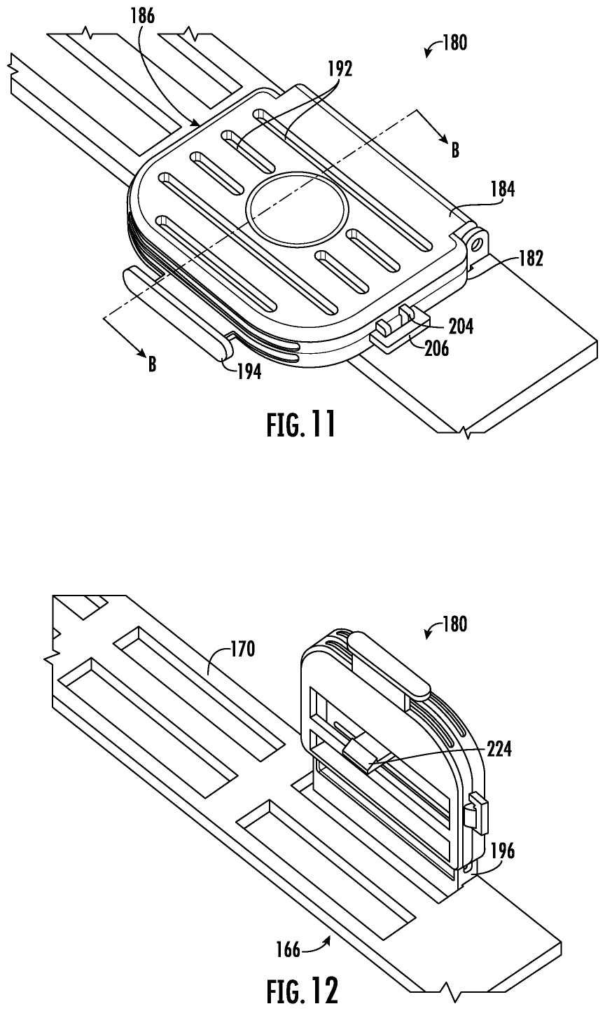

Referring now to FIGS. 11 through 13, a freshener assembly 180 according to another embodiment will be described in detail. Due to the similarities between embodiments described herein, like reference numerals may be used to refer to the same or similar features. In particular, with reference to FIG. 11, freshener assembly 180 may include casing bottom 182 and casing top 184, connected to each other via hinge 186. Casing bottom 182 may include the plurality of bottom apertures 188 while casing top 184 may include the plurality of top apertures 192. Freshener assembly 180 may further include slider tab 194. Freshener assembly 180 may further include latch hook 204 and latch receptacle 206, as described above.

According to this embodiment, connector hook 196 may be rotatably connected to casing bottom 182. In detail, connector hook 196 may be rotatable with respect to casing bottom 182. An axis of rotation of casing bottom 182 with respect to connector hook 196 may be defined along the lateral direction L. For instance, casing 185 may rotate (e.g., upward along the vertical direction V) with respect to exhaust vent 164 when freshener assembly 180 is attached to exhaust vent 164. For instance, casing 185 may rotate between a down position (FIG. 11) and an up position (FIG. 12). Advantageously, freshener assembly 180 may be removed from an airflow from exhaust vent 164 such that a scent release is reduce (e.g., when in the up position).

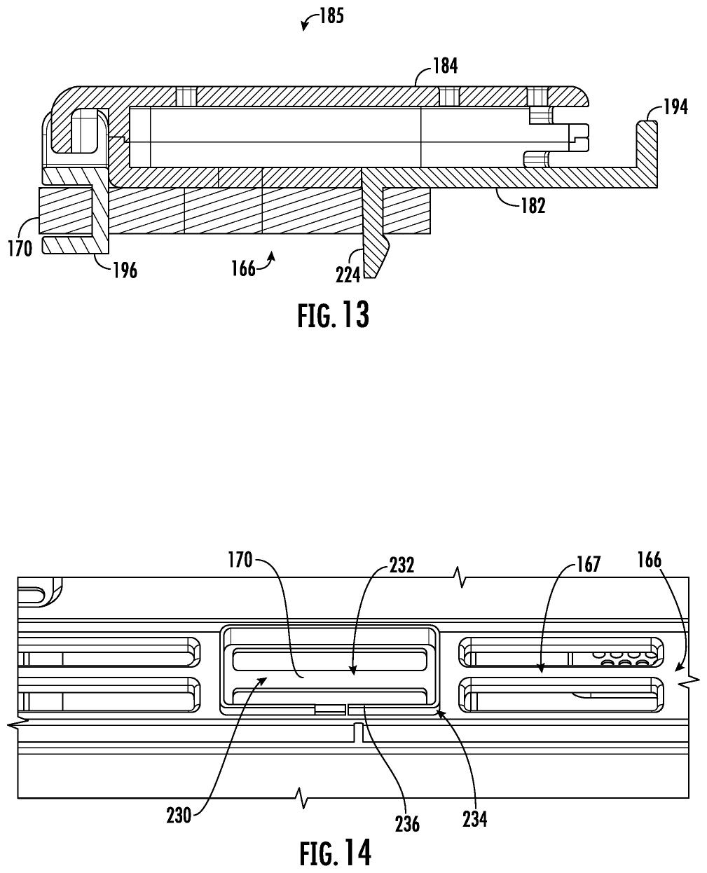

Referring specifically to FIG. 13, connector hook 196 may form a “C” shape. Accordingly, three sides of connector hook 196 may surround grate 166 (e.g., lateral prong 170). Connector hook 196 may be attached to casing top 184 or casing bottom 182. Accordingly, casing 185 may be removable from connector hook 196 to allow access to the receiving space between casing bottom 182 and casing top 184. Additionally or alternatively, one or more fastening means may be incorporated into connector hook 196. For instance, a magnet, an adhesive, a clip, or the like may be included in or on connector hook 196 (or grate 166) to fix connector hook 196 thereto in the installed position. Thus, when casing 185 is rotated to the up position, connector hook 196 may remain in place (e.g., with respect to grate 166).

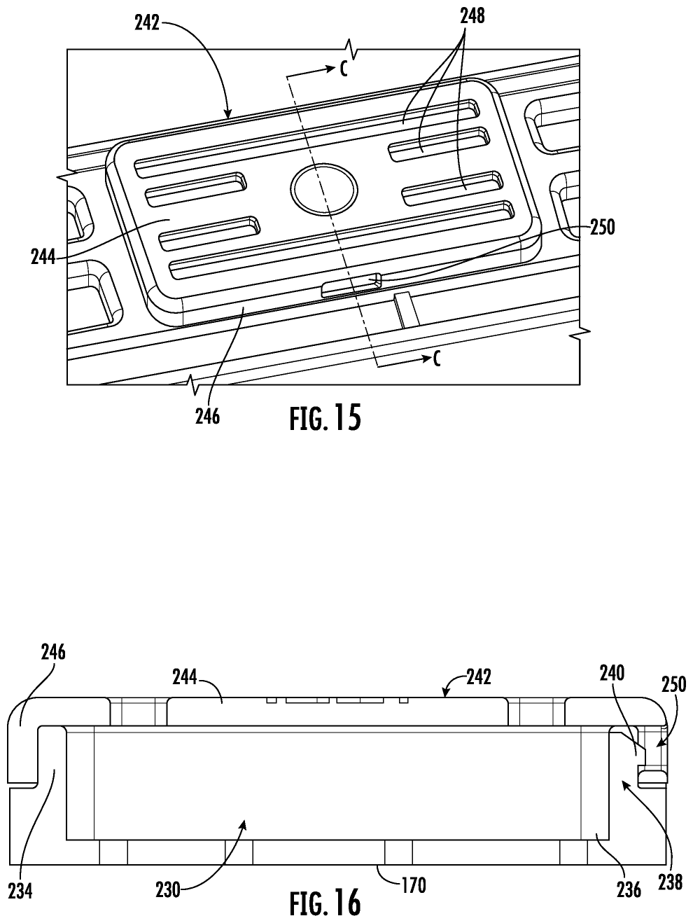

Referring now to FIGS. 14 through 16, a microwave oven appliance 100 according to another embodiment is shown. In particular, an exhaust vent 164 according to another embodiment is shown. Due to the similarities between embodiments described herein, like reference numerals may be used to refer to the same or similar features. In particular, with reference to FIG. 14, exhaust vent 164 may include a recess 230. Recess 230 may be formed into grate 166 (e.g., along the vertical direction V). However, in some instances, recess 230 may be formed into grate 166 along the transverse direction T (e.g., when exhaust vent 164 is formed on a front panel of appliance 100). A bottom surface 232 of recess 230 may thus be provided lower than a top surface 167 of grate 166 (e.g., along the vertical direction V).

Recess 230 may be defined by a perimeter frame 234. For instance, perimeter frame 234 may form a generally rectangular shape (e.g., along the lateral direction L and the transverse direction T). Bottom surface 232 may thus define a bottom of perimeter frame 234. For instance, one or more lateral prongs 170 may form bottom surface 232. Additionally or alternatively, perimeter frame 234 may protrude upward from top surface 167 of grate 166 (e.g., along the vertical direction V). Thus, recess 230 may form a receiving space into which one or more cartridges (e.g., scent cartridges, odor absorbing cartridges, etc.) may be inserted.

Perimeter frame 234 may include a front edge 236. Front edge 236 may include or partially form a frame hook 238. For instance, referring briefly to FIG. 16, frame hook 238 may include a latch portion 240. Latch portion 240 may protrude forward along the transverse direction T. Accordingly, a receiving pocket may be formed below latch portion 240 (e.g., along the vertical direction V).

Microwave oven appliance 100 may further include a cap 242. Cap 242 may be selectively received over top of recess 230. For instance, cap 242 may be removably coupled to perimeter frame 234. Cap 242 may be shaped commensurate to perimeter frame 234. Accordingly, cap 242 may include a base plate 244 and a plurality of walls 246 protruding along the vertical direction V from a perimeter of base plate 244. The plurality of walls 246 may surround perimeter frame 234 when cap 242 is in an installed position. Base plate 244 may include a plurality of apertures 248. The plurality of apertures 248 may extend through base plate 244 along the vertical direction V (e.g., similar to the plurality of top apertures 192). Accordingly, a flow of air form exhaust vent 164 may flow through recess 230 via grate 166 and out through the plurality of apertures 248.

A receiving aperture 250 may be formed in at least one of the plurality of walls 246. For instance, receiving aperture 250 may be configured to interact with frame hook 238 (e.g., when cap 242 is in the installed position). Latch portion 240 may extend at least partially through receiving aperture 250 to restrict an upward movement (e.g., along the vertical direction V) of cap 242. Although frame hook 238 and receiving aperture 250 are shown on a front edge of perimeter frame 234 and cap 242 respectively, it should be understood that a location of each of frame hook 238 and receiving aperture 250 may vary according to specific embodiments. Further, a plurality of receiving apertures 250 may be incorporated (e.g., on each of the plurality of walls 246) while a plurality of frame hooks 238 may also be incorporated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave oven appliance defining a vertical direction, a lateral direction, and a transverse direction, the microwave oven appliance comprising:
a cabinet, the cabinet forming a cooking cavity;
a door rotatably coupled to the cabinet to provide selective access to the cooking cavity;
a ventilation system provided within the cabinet and configured to circulate air, the ventilation system comprising an exhaust vent; and
a freshener assembly attached to the microwave oven appliance at the exhaust vent, the freshener assembly being configured to receive a replaceable scent cartridge, wherein the freshener assembly comprises:
a casing bottom, the casing bottom comprising a plurality of bottom apertures;
a casing top, the casing top comprising a plurality of top apertures, wherein the casing top is selectively connected to the casing bottom; and
a connector hook configured to selectively connect the freshener assembly to the exhaust vent.

2. The microwave oven appliance of claim 1, wherein the connector hook protrudes downward from the casing bottom along the vertical direction, and wherein the freshener assembly further comprises:
a casing snap hook protruding downward from the casing bottom along the vertical direction, the casing snap hook being spaced apart from the connector hook along the transverse direction.

3. The microwave oven appliance of claim 1, wherein the freshener assembly further comprises:
a slider tab protruding forward from casing bottom along the transverse direction.

4. The microwave oven appliance of claim 1, wherein the freshener assembly further comprises:
a holster defining a receiving cavity, wherein the casing top and the casing bottom are selectively received within the receiving cavity.

5. The microwave oven appliance of claim 4, wherein the connector hook protrudes downward from a bottom of the holster along the vertical direction.

6. The microwave oven appliance of claim 5, wherein the freshener assembly further comprises:
a holster snap hook protruding downward from the bottom of the holster along the vertical direction, the holster snap hook being spaced apart from the connector hook along the transverse direction.

7. The microwave oven appliance of claim 6, wherein the holster snap hook is a first holster snap hook, and wherein the freshener assembly further comprises:
a second holster snap hook spaced apart from the first holster snap hook along the lateral direction, wherein the first holster snap hook contacts a first prong of the exhaust vent and the second holster snap hook contacts a second prong of the exhaust vent when the freshener assembly is in an installed position.

8. The microwave oven appliance of claim 1, wherein the connector hook is rotatably coupled to the casing top about an axis of rotation, the axis of rotation extending along the lateral direction.

9. The microwave oven appliance of claim 1, further comprising:
a recess formed into the exhaust vent, wherein the recess is defined by a perimeter frame; and
a cap removably coupled to the perimeter frame.

10. A microwave oven appliance defining a vertical direction, a lateral direction, and a transverse direction, the microwave oven appliance comprising:
a cabinet, the cabinet forming a cooking cavity;
a door rotatably coupled to the cabinet to provide selective access to the cooking cavity;
a ventilation system provided within the cabinet and configured to circulate air, the ventilation system comprising an exhaust vent; and
a freshener assembly attached to the microwave oven appliance at the exhaust vent, the freshener assembly being configured to receive a replaceable scent cartridge, wherein the freshener assembly comprises:
a casing bottom, the casing bottom comprising a plurality of bottom apertures;
a casing top, the casing top comprising a plurality of top apertures, wherein the casing top is selectively connected to the casing bottom;
a latch receptacle protruding from the casing bottom along the lateral direction;
a latch hook protruding from the casing top along the lateral direction, the latch hook being aligned within the latch receptacle to be selectively received therein; and
a connector hook configured to selectively connect the freshener assembly to the exhaust vent.

11. The microwave oven appliance of claim 10, wherein the connector hook protrudes downward from the casing bottom along the vertical direction, and wherein the freshener assembly further comprises:
a casing snap hook protruding downward from the casing bottom along the vertical direction, the casing snap hook being spaced apart from the connector hook along the transverse direction.

12. The microwave oven appliance of claim 10, wherein the freshener assembly further comprises:
a slider tab protruding forward from casing bottom along the transverse direction.

13. The microwave oven appliance of claim 10, wherein the freshener assembly further comprises:
a holster defining a receiving cavity, wherein the casing top and the casing bottom are selectively received within the receiving cavity.

14. The microwave oven appliance of claim 13, wherein the connector hook protrudes downward from a bottom of the holster along the vertical direction.

15. The microwave oven appliance of claim 14, wherein the freshener assembly further comprises:
a holster snap hook protruding downward from the bottom of the holster along the vertical direction, the holster snap hook being spaced apart from the connector hook along the transverse direction.

16. The microwave oven appliance of claim 15, wherein the holster snap hook is a first holster snap hook, and wherein the freshener assembly further comprises:
a second holster snap hook spaced apart from the first holster snap hook along the lateral direction, wherein the first holster snap hook contacts a first prong of the exhaust vent and the second holster snap hook contacts a second prong of the exhaust vent when the freshener assembly is in an installed position.

17. The microwave oven appliance of claim 10, wherein the connector hook is rotatably coupled to the casing top about an axis of rotation, the axis of rotation extending along the lateral direction.

18. The microwave oven appliance of claim 10, further comprising:
a recess formed into the exhaust vent, wherein the recess is defined by a perimeter frame; and
a cap removably coupled to the perimeter frame.
